(19) United States
(12) Patent Application Publication
(10) Pub. No.: US 2019/0210767 A1
(43) Pub. Date: Jul. 11, 2019

(54) Collapsible Container

(71) Applicant: Ray Ainsworth, Jackson, MS (US)

(72) Inventor: Ray Ainsworth, Jackson, MS (US)

(21) Appl. No.: 15/864,799

(22) Filed: Jan. 8, 2018

(51) Int. Cl. B65D 21/08; B65D 25/24; B65D 25/16; B65D 81/38; B65F 1/06

(52) U.S. Cl. CPC B65D 21/086; B65D 25/24; B65F 2220/1063; B65D 81/3813; B65F 1/06; B65D 25/16

(57) ABSTRACT

A collapsible container comprising a frame with a plurality of vertical members connected by pairs of crossed members. Each pair of cross members are pivotally connected at their approximate centers by a pivot pin. The upper and lower ends of the cross members are connected to the vertical members at the foot position and to appropriate slide-able connector, which are attached to the vertical members. A skirt encircles the top of the vertical members. Extending from the skirt can be such features as a durable tapered liner to receive trash, a hooded, insulated liner to be used as a cooler, or a laundry bag. The collapsible garbage container folds into a compact space and can be inserted into an appropriately sized bag for transport.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

This invention relates, to a collapsible container with a frame of crisscrossing, foldable members that permit the container to be folded into a small shape and easily transported for use with garbage collection, as a cooler, or laundry hamper.

### Background of the Invention

This application claims the benefit of U.S. patent application Ser. No. 12/688,067, filed Jan. 15, 2010.

Conventional garbage or trash cans comprise rigid, solid rounded or rectangular sides and a bottom fabricated from metal or synthetic plastic materials, are designed to withstand rough handling, are not foldable or collapsible, and they occupy a substantial amount of space. When these conventional garbage containers are transported each takes up a great deal of space making it inconvenient to transport these conventional garbage containers to sporting events, camping, the beach, a picnic, or even an event in the back yard. In these circumstances, a collapsible garbage container that takes up little space while being transported and can be set up and taken down quickly and easily is desired.

Likewise, coolers are large, cumbersome containers that take up a great deal of space when transported and empty laundry hampers take up space in the laundry room. The present disclosure reveals a collapsible framework that can be easily set up and taken down, takes up very little space when not in use, is durable, and light weight, that can be used for many different functions depending upon the liner attached, thus improving the user's lifestyle and adding convenience to the uses day to day activities.

A number of prior art devices have produced a portable can or garbage bag support. Yet, all of the prior art fails to address needs filled by the current invention. Among these are the need for the container that is strong and durable while also readily and easily foldable into a conveniently transportable shape that can be quickly inserted into a carrying case. Accordingly there is a need for sturdy collapsible container which can be easily and readily set up and taken down to a conveniently transportable shape that overcomes the prior art's shortcomings.

### SUMMARY OF THE INVENTION

The present disclosure reveals a collapsible framework that can be easily set up and taken down, takes up very little space when not in use, is durable, and light weight, that can be used for many different functions depending upon the liner attached, thus improving the user's lifestyle and adding convenience to the uses day to day activities.

As the collapsible container is viewed from the top, the geometric shape may be but is not limited to triangular, rectangular, or pentagonal.

A first use of the collapsible container is with a tapered liner and trash can liners to create a trash receptacle and thus collect waste material. In this embodiment, the collapsible container further comprises a durable, tapered liner, which is made of a material that resists puncture, and does not leak if holding water, that collects spills in the event the trash can liner rips or leaks and wherein the tapered shape facilitates the removal of the trash can liner. In a second embodiment, an insulated, covered liner can be used to create a portable cooler. In a third embodiment, a laundry bag can be attached to create a portable laundry hamper.

### BRIEF DESCRIPTION OF THE SEVERAL VIEWS OF THE DRAWING

FIG. 1 is a perspective view of the first embodiment of the collapsible container in an unfolded state, wherein the collapsible container as viewed from the top is triangular;

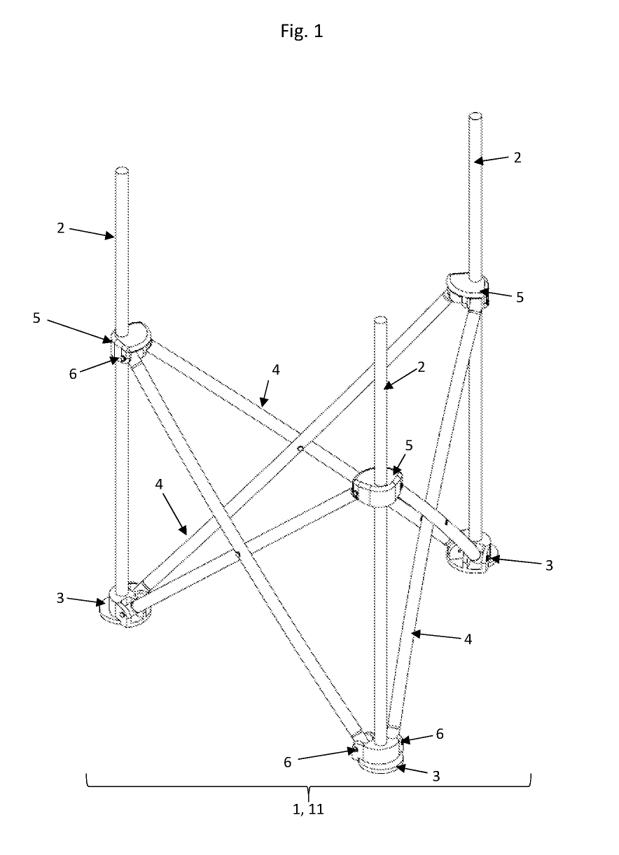

FIG. 2 is a perspective view of the first embodiment of the collapsible container in an unfolded state, wherein the collapsible container as viewed from the top is rectangular;

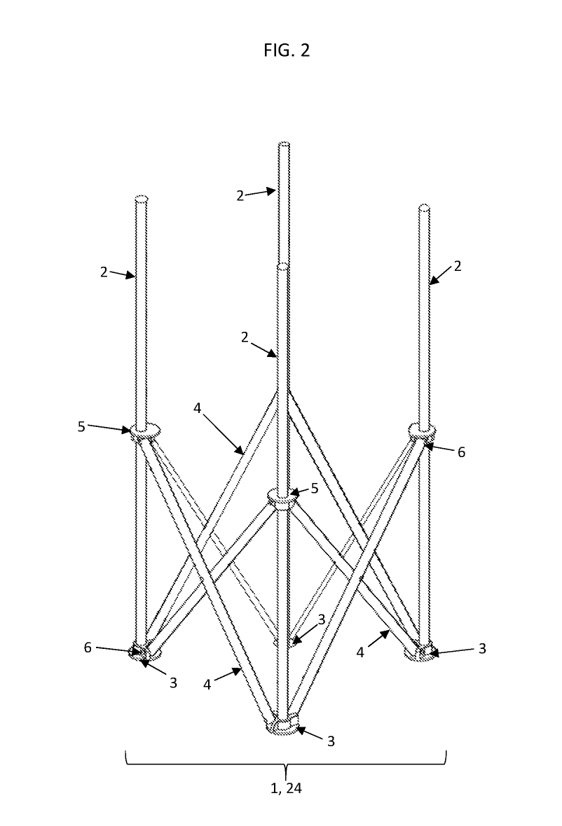

FIG. 3 is a perspective view of the first embodiment of the collapsible container in an unfolded state, wherein the collapsible container as viewed from the top is pentagular;

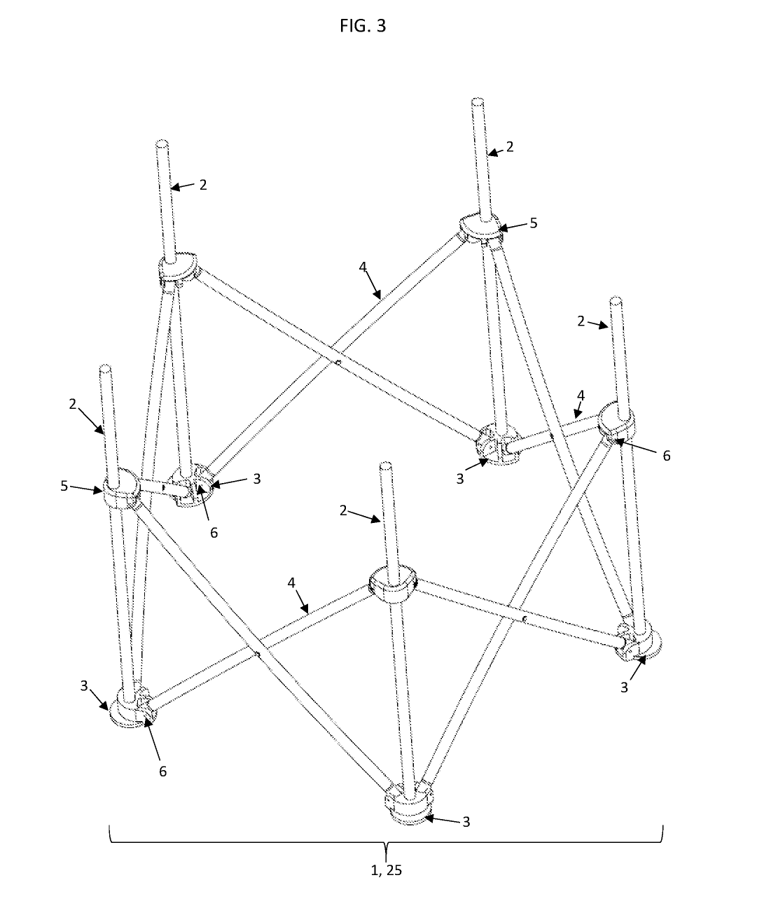

FIG. 4 is a perspective view of the collapsible container in a folded state;

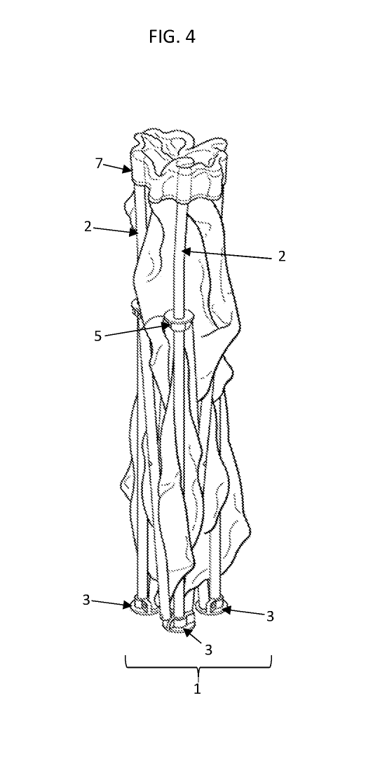

FIG. 5 is a perspective view of a cross member including the upper end, lower end, middle, first side, second side, and the holes in the upper end, lower end, and middle;

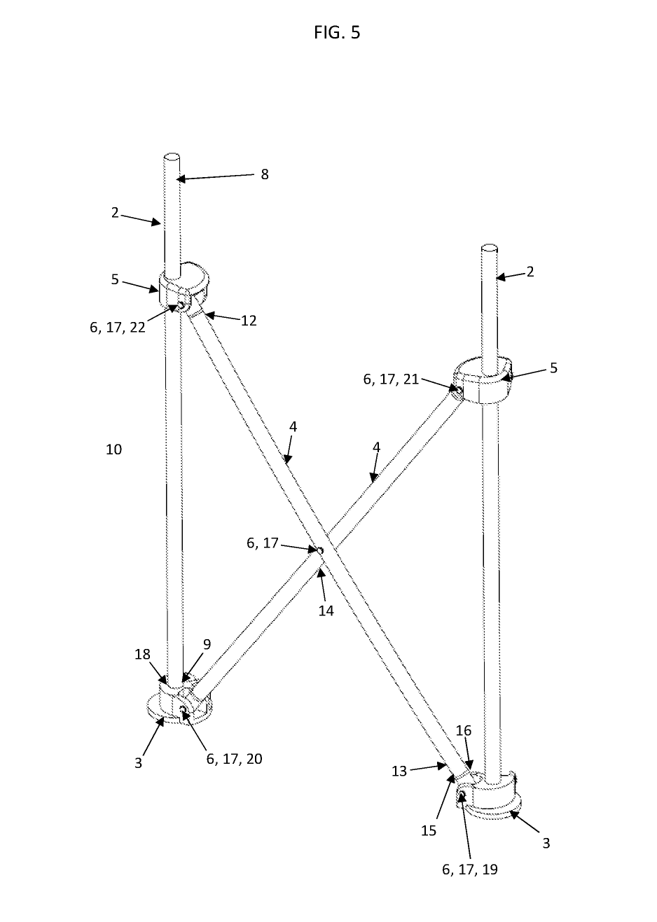

FIG. 6 is a perspective view of the collapsible container in a rectangular shape in an unfolded state to be used as a trash receptacle and with the tapered liner;

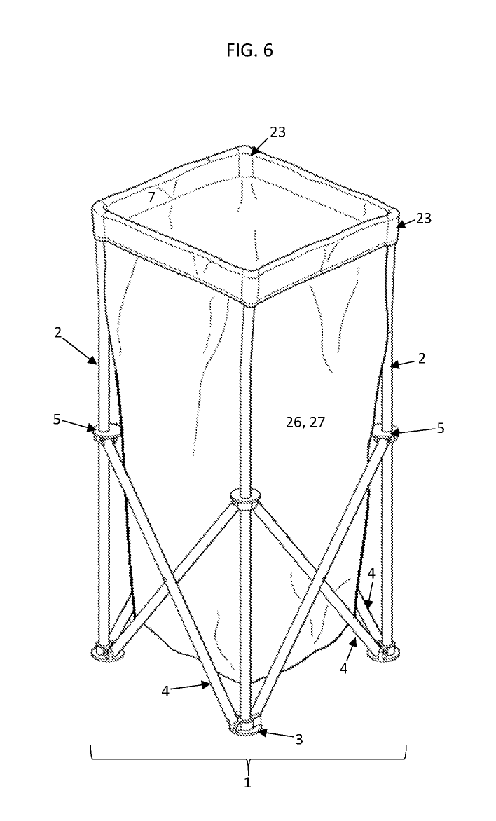

FIG. 7 is an enlarged sectional view of the tapered liner and vertical member connection;

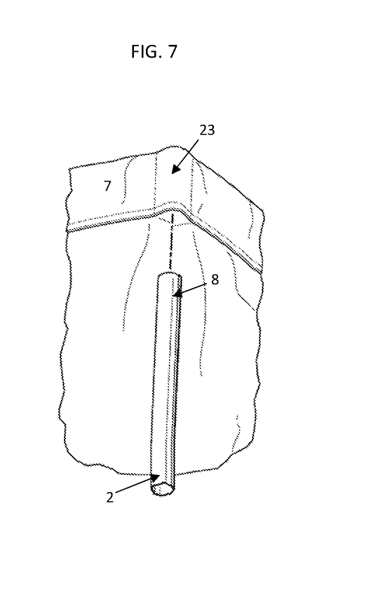

FIG. 8 is a perspective view of the collapsible container in a rectangular shape in an unfolded state to be used as a cooler;

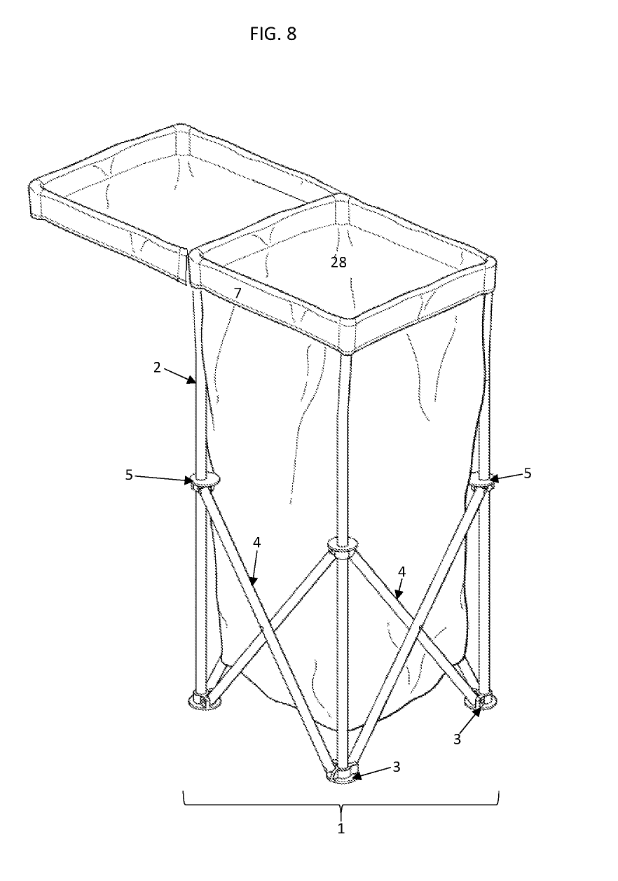

FIG. 9 is a perspective view of the collapsible container in a rectangular in an unfolded state to be used as a laundry hamper.

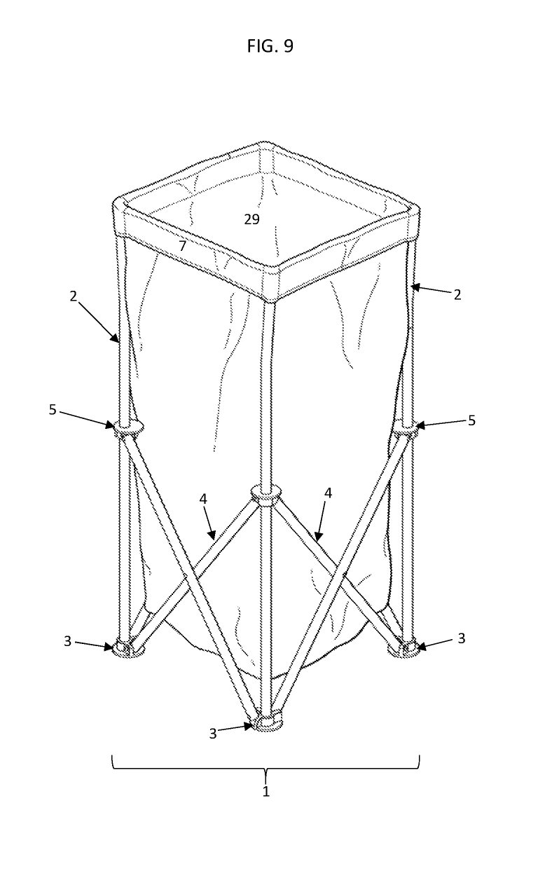

### DETAILED DESCRIPTION OF THE INVENTION

The present disclosure reveals a collapsible container 1 for use as a trash receptacle, cooler, or laundry hamper comprising a plurality of vertical members 2, a plurality of feet 3, a plurality of cross members 4, a plurality of slide-able connections 5, a plurality of pivot pins 6, and a skirt 7.

In the first embodiment 11 of the collapsible container 1, as the collapsible container 1 is viewed from the top, the geometric shape is triangular.

Of the plurality of vertical members 2 there is a first vertical member 2, a second vertical member 2, and a third vertical member 2. Each vertical member 2 of the plurality of vertical members 2 comprises a top 8, a bottom 9, and a length 10.

Of the plurality of cross members 4 there is a first cross member 4, a second cross member 4, a third cross member 4, a fourth cross member 4, and a sixth cross member 4. Each cross member 4 of the plurality of cross members 4 comprising an upper end 12, a lower end 13, a middle 14, a first side 15, and a second side 16, wherein there is a hole 17 in the upper end 12 that passes through the first side 15 to the second side 16, there is a hole 17 in the lower end 13 that passes through the first side 15 to the second side 16, and there is a hole 17 in the middle 14 that passes through the first side 15 to the second side 16.

Of the plurality of feet 3 there is a first foot 3, a second foot 3, and a third foot 3. Each foot 3 of the plurality of feet 3 comprises a receiver 18, a first attachment point 19 and a second attachment point 20 wherein the receiver 18 is sized to have the bottom 9 of a vertical member 2 inserted into the receiver 18 and wherein the bottom 9 of the first vertical member 2 is inserted into the receiver 18 of the first foot 3, the bottom 9 of the second vertical member 2 is inserted into the receiver 18 of the second foot 3, and the bottom 9 of the third vertical member 2 is inserted into the receiver 18 of the third foot 3.

Of the plurality of slide-able connections 5 there is a first connection 5, a second connection 5, and a third connection 5 wherein each slide-able connection 5 of the plurality of slide-able connections 5 is attached to and is capable of sliding along the length 10 of a vertical member 2 of the plurality of vertical members 2, such that the first slide-able connection 5 is attached to the length 10 of the first vertical member 2, the second slide-able connection 5 is attached to the length 10 of the second vertical member 2, and the third slide-able connection 5 is attached to the length 10 of the third vertical member 2. Each slide-able connection 5 further comprises a first connection point 21 and a second connection point 22.

The lower end 13 of the first cross member 4 is attached to the first attachment point 19 of the first foot 3 by a pivot pin 6 of the plurality of pivot pins 6 and the upper end 12 of the first cross member 4 is attached to the second attachment point 20 of the second slide-able connection 5 by a pivot pin 6 of the plurality of pivot pins 6. The lower end 13 of the second cross member 4 is attached to the second attachment point 20 of the second foot 3 by a pivot pin 6 of the plurality of pivot pins 6 and the upper end 12 of the second cross member 4 is attached to the first attachment point 19 of the first slide-able connection 5 by a pivot pin 6 of the plurality of pivot pins 6. The lower end 13 of the third cross member 4 is attached to the first attachment point 19 of the second foot 3 by a pivot pin 6 of the plurality of pivot pins 6 and the upper end 12 of the third cross member 4 is attached to the second attachment point 20 of the third slide-able connection 5 by a pivot pin 6 of the plurality of pivot pins 6. The lower end 13 of the fourth cross member 4 is attached to the second attachment point 20 of the third foot 3 by a pivot pin 6 of the plurality of pivot pins 6 and the upper end 12 of the fourth cross member 4 is attached to the first attachment point 19 of the second slide-able connection 5 by a pivot pin 6 of the plurality of pivot pins 6. The lower end 13 of the fifth cross member 4 is attached to the first attachment point 19 of the third foot 3 by a pivot pin 6 of the plurality of pivot pins 6 and the upper end 12 of the fifth cross member 4 is attached to the second attachment point 20 of the first slide-able connection 5 by a pivot pin 6 of the plurality of pivot pins 6. The lower end 13 of the sixth cross member 4 is attached to the second attachment point 20 of the first foot 3 by a pivot pin 6 of the plurality of pivot pins 6 and the upper end 12 of the sixth cross member 4 is attached to the first attachment point 19 of the third slide-able connection 5 by a pivot pin 6 of the plurality of pivot pins 6.

A pivot pin 6 of the plurality of pivot pins 6 passes through the hole 17 in the middle 14 of the first cross member 4 and through the hole 17 in the middle 14 of the second cross member 4, a pivot pin 6 of the plurality of pivot pins 6 passes through the hole 17 in the middle 14 of the third cross member 4 and through the hole 17 in the middle 14 of the fourth cross member 4, and a pivot pin 6 of the plurality of pivot pins 6 passes through the hole 17 in the middle 14 of the fifth cross member 4 and through the hole 17 in the middle 14 of the sixth cross member 4.

The skirt 7 encircles upper end 12 of the vertical members 2 and comprises a plurality of pouches 23 wherein each pouch 23 is capable of receiving the upper end 12 of a vertical member 2 of the plurality of vertical members 2 such that a first pouch 23 of the plurality of pouches 23 receives the upper end 12 of the first vertical member 2, a second pouch 23 of the plurality of pouches 23 receives the upper end 12 of the third vertical member 2, and a third pouch 23 of the plurality of pouches 23 receives the upper end 12 of the third vertical member 2.

In the second embodiment 24 of the collapsible container 1, as the collapsible container 1 is viewed from the top, the geometric shape is rectangular.

Of the plurality of vertical members 2 there is a first vertical member 2, a second vertical member 2, a third vertical member 2, and a fourth vertical member 2. Each vertical member 2 of the plurality of vertical members 2 comprises a top 8, a bottom 9, and a length 10.

Of the plurality of cross members 4 there is a first cross member 4, a second cross member 4, a third cross member 4, a fourth cross member 4, a sixth cross member 4, a seventh cross member 4, and an eighth cross member 4. Each cross member 4 of the plurality of cross members 4 comprising an upper end 12, a lower end 13, a middle 14, a first side 15, and a second side 16, wherein there is a hole 17 in the upper end 12 that passes through the first side 15 to the second side 16, there is a hole 17 in the lower end 13 that passes through the first side 15 to the second side 16, and there is a hole 17 in the middle 14 that passes through the first side 15 to the second side 16.

Of the plurality of feet 3 there is a first foot 3, a second foot 3, a third foot 3, and a fourth foot 3. Each foot 3 of the plurality of feet 3 comprises a receiver 18, a first attachment point 19 and a second attachment point 20 wherein the receiver 18 is sized to have the bottom 9 of a vertical member 2 inserted into the receiver 18 and wherein the bottom 9 of the first vertical member 2 is inserted into the receiver 18 of the first foot 3, the bottom 9 of the second vertical member 2 is inserted into the receiver 18 of the second foot 3, the bottom 9 of the third vertical member 2 is inserted into the receiver 18 of the third foot 3, and the bottom 9 of the fourth vertical member 2 is inserted into the receiver 18 of the fourth foot 3.

Of the plurality of slide-able connections 5 there is a first slide-able connection 5, a second slide-able connection 5, a third slide-able connection 5, and a fourth slide-able connection 5 wherein each slide-able connection 5 of the plurality of slide-able connections 5 is attached to and is capable of sliding along the length 10 of a vertical member 2, such that the first slide-able connection 5 is attached to the length 10 of the first vertical member 2, the second slide-able connection 5 is attached to the length 10 of the second vertical member 2, the third slide-able connection 5 is attached to the length 10 of the third vertical member 2, and the fourth slide-able connection 5 is attached to the length 10 of the fourth vertical member 2. Each slide-able connection 5 further comprises a first connection point 21 and a second connection point 22;

The lower end 13 of the first cross member 4 is attached to the first attachment point 19 of the first foot 3 by a pivot pin 6 of the plurality of pivot pins 6 and the upper end 12 of the first cross member 4 is attached to the second attachment point 20 of the second slide-able connection 5 by a pivot pin 6 of the plurality of pivot pins 6. The lower end 13 of the second cross member 4 is attached to the second attachment point 20 of the second foot 3 by a pivot pin 6 of the plurality of pivot pins 6 and the upper end 12 of the second cross member 4 is attached to the first attachment point 19 of the first slide-able connection 5 by a pivot pin 6 of the plurality of pivot pins 6. The lower end 13 of the third cross member 4 is attached to the first attachment point 19 of the second foot 3 by a pivot pin 6 of the plurality of pivot pins 6 and the upper end 12 of the third cross member 4 is attached to the second attachment point 20 of the third slide-able connection 5 by a pivot pin 6 of the plurality of pivot pins 6. The lower end 13 of the fourth cross member 4 is attached to the second attachment point 20 of the third foot 3 by a pivot pin 6 of the plurality of pivot pins 6 and the upper end 12 of the fourth cross member 4 is attached to the first attachment point 19 of the second slide-able connection 5 by a pivot pin 6 of the plurality of pivot pins 6. The lower end 13 of the fifth cross member 4 is attached to the first attachment point 19 of the third foot 3 by a pivot pin 6 of the plurality of pivot pins 6 and the upper end 12 of the fifth cross member 4 is attached to the second attachment point 20 of the fourth slide-able connection 5 by a pivot pin 6 of the plurality of pivot pins 6. The lower end 13 of the sixth cross member 4 is attached to the second attachment point 20 of the fourth foot 3 by a pivot pin 6 of the plurality of pivot pins 6 and the upper end 12 of the sixth cross member 4 is attached to the first attachment point 19 of the third slide-able connection 5 by a pivot pin 6 of the plurality of pivot pins 6. The lower end 13 of the seventh cross member 4 is attached to the first attachment point 19 of the fourth foot 3 by a pivot pin 6 of the plurality of pivot pins 6 and the upper end 12 of the seventh cross member 4 is attached to the second attachment point 20 of the first slide-able connection 5 by a pivot pin 6 of the plurality of pivot pins 6. The lower end 13 of the eighth cross member 4 is attached to the second attachment point 20 of the first foot 3 by a pivot pin 6 of the plurality of pivot pins 6 and the upper end 12 of the eighth cross member 4 is attached to the first attachment point 19 of the fourth slide-able connection 5 by a pivot pin 6 of the plurality of pivot pins 6.

A pivot pin 6 of the plurality of pivot pins 6 passes through the hole 17 in the middle 14 of the first cross member 4 and through the hole 17 in the middle 14 of the second cross member 4, a pivot pin 6 of the plurality of pivot pins 6 passes through the hole 17 in the middle 14 of the third cross member 4 and through the hole 17 in the middle 14 of the fourth cross member 4, a pivot pin 6 of the plurality of pivot pins 6 passes through the hole 17 in the middle 14 of the fifth cross member 4 and through the hole 17 in the middle 14 of the sixth cross member 4, and a pivot pin 6 of the plurality of pivot pins 6 passes through the hole 17 in the middle 14 of the seventh cross member 4 and through the hole 17 in the middle 14 of the eighth cross member 4.

The skirt encircles upper end 12 of the vertical members 2 and comprises a plurality of pouches 23 wherein each pouch 23 is capable of receiving the upper end 12 of a vertical member 2 of the plurality of vertical members 2 such that a first pouch 23 of the plurality of pouches 23 receives the upper end 12 of the first vertical member 2, a second pouch 23 of the plurality of pouches 23 receives the upper end 12 of the third vertical member 2, a third pouch 23 of the plurality of pouches 23 receives the upper end 12 of the third vertical member 2, and a fourth pouch 23 of the plurality of pouches 23 receives the upper end 12 of the fourth vertical member 2.

In the third embodiment 25 of the collapsible container 1, as the collapsible container 1 is viewed from the top, the geometric shape is pentangular.

Of the plurality of vertical members 2 there is a first vertical member 2, a second vertical member 2, a third vertical member 2, a fourth vertical member 2, and a fifth vertical member 2. Each vertical member 2 of the plurality of vertical members 2 comprises a top 8, a bottom 9, and a length 10.

Of the plurality of cross members 4 there is a first cross member 4, a second cross member 4, a third cross member 4, a fourth cross member 4, a sixth cross member 4, a seventh cross member 4, an eighth cross member 4, a ninth cross member 4, and a tenth cross member 4. Each cross member 4 of the plurality of cross members 4 comprising an upper end 12, a lower end 13, a middle 14, a first side 15, and a second side 16, wherein there is a hole 17 in the upper end 12 that passes through the first side 15 to the second side 16, there is a hole 17 in the lower end 13 that passes through the first side 15 to the second side 16, and there is a hole 17 in the middle 14 that passes through the first side 15 to the second side 16.

Of the plurality of feet 3 there is a first foot 3, a second foot 3, a third foot 3, a fourth foot 3, and a fifth foot 3. Each foot 3 of the plurality of feet 3 comprises a receiver 18, a first attachment point 19 and a second attachment point 20 wherein the receiver 18 is sized to have the bottom 9 of a vertical member 2 inserted into the receiver 18 and wherein the bottom 9 of the first vertical member 2 is inserted into the receiver 18 of the first foot 3, the bottom 9 of the second vertical member 2 is inserted into the receiver 18 of the second foot 3, the bottom 9 of the third vertical member 2 is inserted into the receiver 18 of the third foot 3, the bottom 9 of the fourth vertical member 2 is inserted into the receiver 18 of the fourth foot 3, the bottom 9 of the fifth vertical member 2 is inserted into the receiver 18 of the fifth foot 3.

Of the plurality of slide-able connections 5 there is a first slide-able connection 5, a second slide-able connection 5, a third slide-able connection 5, a fourth slide-able connection 5, and a fifth slide-able connection 5 wherein each slide-able connection 5 of the plurality of slide-able connections 5 is attached to and is capable of sliding along the length 10 of a vertical member 2, such that the first slide-able connection 5 is attached to the length 10 of the first vertical member 2, the second slide-able connection 5 is attached to the length 10 of the second vertical member 2, the third slide-able connection 5 is attached to the length 10 of the third vertical member 2, the fourth slide-able connection 5 is attached to the length 10 of the fourth vertical member 2, and the fifth slide-able connection 5 is attached to the length 10 of the fifth vertical member 2. Each slide-able connection 5 further comprises a first connection point 21 and a second connection point 22;

The lower end 13 of the first cross member 4 is attached to the first attachment point 19 of the first foot 3 by a pivot pin 6 of the plurality of pivot pins 6 and the upper end 12 of the first cross member 4 is attached to the second attachment point 20 of the second slide-able connection 5 by a pivot pin 6 of the plurality of pivot pins 6. The lower end 13 of the second cross member 4 is attached to the second attachment point 20 of the second foot 3 by a pivot pin 6 of the plurality of pivot pins 6 and the upper end 12 of the second cross member 4 is attached to the first attachment point 19 of the first slide-able connection 5 by a pivot pin 6 of the plurality of pivot pins 6. The lower end 13 of the third cross member 4 is attached to the first attachment point 19 of the second foot 3 by a pivot pin 6 of the plurality of pivot pins 6 and the upper end 12 of the third cross member 4 is attached to the second attachment point 20 of the third slide-able connection 5 by a pivot pin 6 of the plurality of pivot pins 6. The lower end 13 of the fourth cross member 4 is attached to the second attachment point 20 of the third foot 3 by a pivot pin 6 of the plurality of pivot pins 6 and the upper end 12 of the fourth cross member 4 is attached to the first attachment point 19 of the second slide-able connection 5 by a pivot pin 6 of the plurality of pivot pins 6. The lower end 13 of the fifth cross member 4 is attached to the first attachment point 19 of the third foot 3 by a pivot pin 6 of the plurality of pivot pins 6 and the upper end 12 of the fifth cross member 4 is attached to the second attachment point 20 of the fourth slide-able connection 5 by a pivot pin 6 of the plurality of pivot pins 6. The lower end 13 of the sixth cross member 4 is attached to the second attachment point 20 of the fourth foot 3 by a pivot pin 6 of the plurality of pivot pins 6 and the upper end 12 of the sixth cross member 4 is attached to the first attachment point 19 of the third slide-able connection 5 by a pivot pin 6 of the plurality of pivot pins 6. The lower end 13 of the seventh cross member 4 is attached to the first attachment point 19 of the fourth foot 3 by a pivot pin 6 of the plurality of pivot pins 6 and the upper end 12 of the seventh cross member 4 is attached to the second attachment point 20 of the fifth slide-able connection 5 by a pivot pin 6 of the plurality of pivot pins 6. The lower end 13 of the eighth cross member 4 is attached to the second attachment point 20 of the fourth foot 3 by a pivot pin 6 of the plurality of pivot pins 6 and the upper end 12 of the eighth cross member 4 is attached to the first attachment point 19 of the fifth slide-able connection 5 by a pivot pin 6 of the plurality of pivot pins 6. The lower end 13 of the ninth cross member 4 is attached to the first attachment point 19 of the fifth foot 3 by a pivot pin 6 of the plurality of pivot pins 6 and the upper end 12 of the seventh cross member 4 is attached to the second attachment point 20 of the first slide-able connection 5 by a pivot pin 6 of the plurality of pivot pins 6. The lower end 13 of the tenth cross member 4 is attached to the second attachment point 20 of the first foot 3 by a pivot pin 6 of the plurality of pivot pins 6 and the upper end 12 of the eighth cross member 4 is attached to the first attachment point 19 of the fifth slide-able connection 5 by a pivot pin 6 of the plurality of pivot pins 6.

A pivot pin 6 of the plurality of pivot pins 6 passes through the hole 17 in the middle 14 first cross member 4 and through the hole 17 in the middle 14 of the second cross member 4, a pivot pin 6 of the plurality of pivot pins 6 passes through the hole 17 in the middle 14 of the third cross member 4 and through the hole 17 in the middle 14 of the fourth cross member 4, a pivot pin 6 of the plurality of pivot pins 6 passes through the hole 17 in the middle 14 of the fifth cross member 4 and through the hole 17 in the middle 14 of the sixth cross member 4, a pivot pin 6 of the plurality of pivot pins 6 passes through the hole 17 in the middle 14 of the seventh cross member 4 and through the hole 17 in the middle 14 of the eighth cross member 4, and a pivot pin 6 of the plurality of pivot pins 6 passes through the hole 17 in the middle 14 of the ninth cross member 4 and through the hole 17 in the middle 14 of the tenth cross member 4.

The skirt encircles upper end 12 of the vertical members 2 and comprises a plurality of pouches 23 wherein each pouch 23 is capable of receiving the upper end 12 of a vertical member 2 of the plurality of vertical members 2 such that a first pouch 23 of the plurality of pouches 23 receives the upper end 12 of the first vertical member 2, a second pouch 23 of the plurality of pouches 23 receives the upper end 12 of the third vertical member 2, a third pouch 23 of the plurality of pouches 23 receives the upper end 12 of the third vertical member 2, a fourth pouch 23 of the plurality of pouches 23 receives the upper end 12 of the fourth vertical member 2, and a fifth pouch 23 of the plurality of pouches 23 receives the upper end 12 of the fifth vertical member 2.

In any of the embodiment of the collapsible container 1, the skirt 7 may further comprise a tapered liner that extends from the skirt 7 to form a trash receptacle 27, wherein the durable, tapered liner, is made of a material that resists puncture, and does not leak if holding water, that collects spills in the event the trash can liner rips or leaks and wherein the tapered shape facilitates the removal of the trash can liner; an insulated, covered liner that extends from the skirt 7 to form a cooler 28; or a laundry bag 29 that extends from the skirt 7.

What is claimed:

1. A collapsible container for use as a trash receptacle, cooler, or laundry hamper comprising:
a plurality of vertical members, a plurality of feet, a plurality of cross members, a plurality of slide-able connections, a plurality of pivot pins, and a skirt;
of the plurality of vertical members there is a first vertical member, a second vertical member, and a third vertical member;
each vertical member of the plurality of vertical members comprises a top, a bottom, and a length;
of the plurality of cross members there is a first cross member, a second cross member, a third cross member, a fourth cross member, and a sixth cross member;
each cross member of the plurality of cross members comprising an upper end, a lower end, a middle, a first side, and a second side, wherein there is a hole in the upper end that passes through the first side to the second side, there is a hole in the lower end that passes through the first side to the second side, and there is a hole in the middle that passes through the first side to the second side;
of the plurality of feet there is a first foot, a second foot, and a third foot;
each foot of the plurality of feet comprises a receiver, a first attachment point and a second attachment point wherein the receiver is sized to have the bottom of a vertical member inserted into the receiver and wherein the bottom of the first vertical member is inserted into the receiver of the first foot, the bottom of the second vertical member is inserted into the receiver of the second foot, and the bottom of the third vertical member is inserted into the receiver of the third foot;
of the plurality of slide-able connections there is a first connection, a second connection, and a third connection wherein each slide-able connection of the plurality of slide-able connections is attached to and is capable of sliding along the length of a vertical member, such that the first slide-able connection is attached to the length of the first vertical member, the second slide-able connection is attached to the length of the second vertical member, and the third slide-able connection is attached to the length of the third vertical member;
each slide-able connection further comprises a first connection point and a second connection point;
the lower end of the first cross member is attached to the first attachment point of the first foot by a pivot pin of the plurality of pivot pins and the upper end of the first cross member is attached to the second attachment point of the second slide-able connection by a pivot pin of the plurality of pivot pins;
the lower end of the second cross member is attached to the second attachment point of the second foot by a pivot pin of the plurality of pivot pins and the upper end of the second cross member is attached to the first attachment point of the first slide-able connection by a pivot pin of the plurality of pivot pins;
the lower end of the third cross member is attached to the first attachment point of the second foot by a pivot pin of the plurality of pivot pins and the upper end of the third cross member is attached to the second attachment point of the third slide-able connection by a pivot pin of the plurality of pivot pins;
the lower end of the fourth cross member is attached to the second attachment point of the third foot by a pivot pin of the plurality of pivot pins and the upper end of the fourth cross member is attached to the first attachment point of the second slide-able connection by a pivot pin of the plurality of pivot pins;
the lower end of the fifth cross member is attached to the first attachment point of the third foot by a pivot pin of the plurality of pivot pins and the upper end of the fifth cross member is attached to the second attachment point of the first slide-able connection by a pivot pin of the plurality of pivot pins;
the lower end of the sixth cross member is attached to the second attachment point of the first foot by a pivot pin of the plurality of pivot pins and the upper end of the sixth cross member is attached to the first attachment point of the third slide-able connection by a pivot pin of the plurality of pivot pins;
a pivot pin of the plurality of pivot pins passes through the middle hole in the first cross member and through the hole in the middle of the second cross member, a pivot pin of the plurality of pivot pins passes through the middle hole in the third cross member and through the hole in the middle of the fourth cross member, and a pivot pin of the plurality of pivot pins passes through the middle hole in the fifth cross member and through the hole in the middle of the sixth cross member; and
the skirt encircles upper end of the vertical members and comprises a plurality of pouches wherein each pouch is capable of receiving the upper end of a vertical member of the plurality of vertical members such that a first pouch of the plurality of pouches receives the upper end of the first vertical member, a second pouch of the plurality of pouches receives the upper end of the third vertical member, and a third pouch of the plurality of pouches receives the upper end of the third vertical member.

2. The collapsible container of claim 1 wherein the skirt further comprises a tapered liner that extends from the skirt to form a trash receptacle.

3. The collapsible container of claim 1 wherein the skirt further comprises an insulated, covered liner that extends from the skirt to form a cooler.

4. The collapsible container of claim 1 wherein the skirt further comprises a laundry bag that extends from the skirt to form a laundry hamper.

5. A collapsible container for use as a trash receptacle, cooler, or laundry hamper comprising:
a plurality of vertical members, a plurality of feet, a plurality of cross members, a plurality of slide-able connections, a plurality of pivot pins, and a skirt;
of the plurality of vertical members there is a first vertical member, a second vertical member, a third vertical member, and a fourth vertical member;
each vertical member of the plurality of vertical members comprises a top, a bottom, and a length;
of the plurality of cross members there is a first cross member, a second cross member, a third cross member, a fourth cross member, a sixth cross member, a seventh cross member, and an eighth cross member;
each cross member of the plurality of cross members comprising an upper end, a lower end, a middle, a first side, and a second side, wherein there is a hole in the upper end that passes through the first side to the second side, there is a hole in the lower end that passes through the first side to the second side, and there is a hole in the middle that passes through the first side to the second side;
of the plurality of feet there is a first foot, a second foot, a third foot, and a fourth foot;
each foot of the plurality of feet comprises a receiver, a first attachment point and a second attachment point wherein the receiver is sized to have the bottom of a vertical member inserted into the receiver and wherein the bottom of the first vertical member is inserted into the receiver of the first foot, the bottom of the second vertical member is inserted into the receiver of the second foot, the bottom of the third vertical member is inserted into the receiver of the third foot, and the bottom of the fourth vertical member is inserted into the receiver of the fourth foot;
of the plurality of slide-able connections there is a first slide-able connection, a second slide-able connection, a third slide-able connection, and a fourth slide-able connection wherein each slide-able connection of the plurality of slide-able connections is attached to and is capable of sliding along the length of a vertical member, such that the first slide-able connection is attached to the length of the first vertical member, the second slide-able connection is attached to the length of the second vertical member, the third slide-able connection is attached to the length of the third vertical member, and the fourth slide-able connection is attached to the length of the fourth vertical member;
each slide-able connection further comprises a first connection point and a second connection point;
the lower end of the first cross member is attached to the first attachment point of the first foot by a pivot pin of the plurality of pivot pins and the upper end of the first cross member is attached to the second attachment point of the second slide-able connection by a pivot pin of the plurality of pivot pins;
the lower end of the second cross member is attached to the second attachment point of the second foot by a pivot pin of the plurality of pivot pins and the upper end of the second cross member is attached to the first attachment point of the first slide-able connection by a pivot pin of the plurality of pivot pins;
the lower end of the third cross member is attached to the first attachment point of the second foot by a pivot pin of the plurality of pivot pins and the upper end of the third cross member is attached to the second attachment point of the third slide-able connection by a pivot pin of the plurality of pivot pins;
the lower end of the fourth cross member is attached to the second attachment point of the third foot by a pivot pin of the plurality of pivot pins and the upper end of the fourth cross member is attached to the first attachment point of the second slide-able connection by a pivot pin of the plurality of pivot pins;
the lower end of the fifth cross member is attached to the first attachment point of the third foot by a pivot pin of the plurality of pivot pins and the upper end of the fifth cross member is attached to the second attachment point of the fourth slide-able connection by a pivot pin of the plurality of pivot pins;
the lower end of the sixth cross member is attached to the second attachment point of the fourth foot by a pivot pin of the plurality of pivot pins and the upper end of the sixth cross member is attached to the first attachment point of the third slide-able connection by a pivot pin of the plurality of pivot pins;
the lower end of the seventh cross member is attached to the first attachment point of the fourth foot by a pivot pin of the plurality of pivot pins and the upper end of the seventh cross member is attached to the second attachment point of the first slide-able connection by a pivot pin of the plurality of pivot pins;
the lower end of the eighth cross member is attached to the second attachment point of the first foot by a pivot pin of the plurality of pivot pins and the upper end of the eighth cross member is attached to the first attachment point of the fourth slide-able connection by a pivot pin of the plurality of pivot pins;
a pivot pin of the plurality of pivot pins passes through the middle hole in the first cross member and through the hole in the middle of the second cross member, a pivot pin of the plurality of pivot pins passes through the middle hole in the third cross member and through the hole in the middle of the fourth cross member, a pivot pin of the plurality of pivot pins passes through the middle hole in the fifth cross member and through the hole in the middle of the sixth cross member, and a pivot pin of the plurality of pivot pins passes through the middle hole in the seventh cross member and through the hole in the middle of the eighth cross member; and
the skirt encircles upper end of the vertical members and comprises a plurality of pouches wherein each pouch is capable of receiving the upper end of a vertical member of the plurality of vertical members such that a first pouch of the plurality of pouches receives the upper end of the first vertical member, a second pouch of the plurality of pouches receives the upper end of the third vertical member, a third pouch of the plurality of pouches receives the upper end of the third vertical member, and a fourth pouch of the plurality of pouches receives the upper end of the fourth vertical member.

6. The collapsible container of claim 5 wherein the skirt further comprises a tapered liner that extends from the skirt to form a trash receptacle.

7. The collapsible container of claim 5 wherein the skirt further comprises an insulated, covered liner that extends from the skirt to form a cooler.

8. The collapsible container of claim 5 wherein the skirt further comprises a laundry bag that extends from the skirt to form a laundry hamper.

9. A collapsible container for use as a trash receptacle, cooler, or laundry hamper comprising:
a plurality of vertical members, a plurality of feet, a plurality of cross members, a plurality of slide-able connections, a plurality of pivot pins, and a skirt;
of the plurality of vertical members there is a first vertical member, a second vertical member, a third vertical member, a fourth vertical member, and a fifth vertical member;
each vertical member of the plurality of vertical members comprises a top, a bottom, and a length;
of the plurality of cross members there is a first cross member, a second cross member, a third cross member, a fourth cross member, a sixth cross member, a seventh cross member, an eighth cross member, a ninth cross member, and a tenth cross member;
each cross member of the plurality of cross members comprising an upper end, a lower end, a middle, a first side, and a second side, wherein there is a hole in the upper end that passes through the first side to the second side, there is a hole in the lower end that passes through the first side to the second side, and there is a hole in the middle that passes through the first side to the second side;
of the plurality of feet there is a first foot, a second foot, a third foot, a fourth foot, and a fifth foot;
each foot of the plurality of feet comprises a receiver, a first attachment point and a second attachment point wherein the receiver is sized to have the bottom of a vertical member inserted into the receiver and wherein the bottom of the first vertical member is inserted into the receiver of the first foot, the bottom of the second vertical member is inserted into the receiver of the second foot, the bottom of the third vertical member is inserted into the receiver of the third foot, the bottom of the fourth vertical member is inserted into the receiver of the fourth foot, the bottom of the fifth vertical member is inserted into the receiver of the fifth foot;
of the plurality of slide-able connections there is a first slide-able connection, a second slide-able connection, a third slide-able connection, a fourth slide-able connection, and a fifth slide-able connection wherein each slide-able connection of the plurality of slide-able connections is attached to and is capable of sliding along the length of a vertical member, such that the first slide-able connection is attached to the length of the first vertical member, the second slide-able connection is attached to the length of the second vertical member, the third slide-able connection is attached to the length of the third vertical member, the fourth slide-able connection is attached to the length of the fourth vertical member, and the fifth slide-able connection is attached to the length of the fifth vertical member;
each slide-able connection further comprises a first connection point and a second connection point;
the lower end of the first cross member is attached to the first attachment point of the first foot by a pivot pin of the plurality of pivot pins and the upper end of the first cross member is attached to the second attachment point of the second slide-able connection by a pivot pin of the plurality of pivot pins;
the lower end of the second cross member is attached to the second attachment point of the second foot by a pivot pin of the plurality of pivot pins and the upper end of the second cross member is attached to the first attachment point of the first slide-able connection by a pivot pin of the plurality of pivot pins;
the lower end of the third cross member is attached to the first attachment point of the second foot by a pivot pin of the plurality of pivot pins and the upper end of the third cross member is attached to the second attachment point of the third slide-able connection by a pivot pin of the plurality of pivot pins;
the lower end of the fourth cross member is attached to the second attachment point of the third foot by a pivot pin of the plurality of pivot pins and the upper end of the fourth cross member is attached to the first attachment point of the second slide-able connection by a pivot pin of the plurality of pivot pins;
the lower end of the fifth cross member is attached to the first attachment point of the third foot by a pivot pin of the plurality of pivot pins and the upper end of the fifth cross member is attached to the second attachment point of the fourth slide-able connection by a pivot pin of the plurality of pivot pins;
the lower end of the sixth cross member is attached to the second attachment point of the fourth foot by a pivot pin of the plurality of pivot pins and the upper end of the sixth cross member is attached to the first attachment point of the third slide-able connection by a pivot pin of the plurality of pivot pins;
the lower end of the seventh cross member is attached to the first attachment point of the fourth foot by a pivot pin of the plurality of pivot pins and the upper end of the seventh cross member is attached to the second attachment point of the fifth slide-able connection by a pivot pin of the plurality of pivot pins;
the lower end of the eighth cross member is attached to the second attachment point of the fourth foot by a pivot pin of the plurality of pivot pins and the upper end of the eighth cross member is attached to the first attachment point of the fifth slide-able connection by a pivot pin of the plurality of pivot pins;
the lower end of the ninth cross member is attached to the first attachment point of the fifth foot by a pivot pin of the plurality of pivot pins and the upper end of the seventh cross member is attached to the second attachment point of the first slide-able connection by a pivot pin of the plurality of pivot pins;
the lower end of the tenth cross member is attached to the second attachment point of the first foot by a pivot pin of the plurality of pivot pins and the upper end of the eighth cross member is attached to the first attachment point of the fifth slide-able connection by a pivot pin of the plurality of pivot pins;
a pivot pin of the plurality of pivot pins passes through the middle hole in the first cross member and through the hole in the middle of the second cross member, a pivot pin of the plurality of pivot pins passes through the middle hole in the third cross member and through the hole in the middle of the fourth cross member, a pivot pin of the plurality of pivot pins passes through the middle hole in the fifth cross member and through the hole in the middle of the sixth cross member, a pivot pin of the plurality of pivot pins passes through the middle hole in the seventh cross member and through the hole in the middle of the eighth cross member, and a pivot pin of the plurality of pivot pins passes through the middle hole in the ninth cross member and through the hole in the middle of the tenth cross member; and
the skirt encircles upper end of the vertical members and comprises a plurality of pouches wherein each pouch is capable of receiving the upper end of a vertical member of the plurality of vertical members such that a first pouch of the plurality of pouches receives the upper end of the first vertical member, a second pouch of the plurality of pouches receives the upper end of the third vertical member, a third pouch of the plurality of pouches receives the upper end of the third vertical member, a fourth pouch of the plurality of pouches receives the upper end of the fourth vertical member, and a fifth pouch of the plurality of pouches receives the upper end of the fifth vertical member.

10. The collapsible container of claim 9 wherein the skirt further comprises a tapered liner that extends from the skirt to form a trash receptacle.

11. The collapsible container of claim 9 wherein the skirt further comprises an insulated, covered liner that extends from the skirt to form a cooler.

12. The collapsible container of claim 9 wherein the skirt further comprises a laundry bag that extends from the skirt to form a laundry hamper.
